(19) United States
(12) Patent Application Publication
(10) Pub. No.: US 2003/0033683 A1
(43) Pub. Date: Feb. 20, 2003

(54) WIPER BLADE FOR CLEANING MOTOR VEHICLE WINDOWS

(76) Inventor: THOMAS KOTLARSKI, BUEHLERTAL (DE)

Correspondence Address: STRIKER STRIKER & STENBY, 103 EAST NECK ROAD, HUNTINGTON, NY, 11743

(21) Appl. No.: 09/445,047

(22) PCT Filed: Jan. 11, 1999
(86) PCT No.: PCT/DE99/00031

(30) Foreign Application Priority Data
Apr. 1, 1998 (DE) 198 14 609.4

(51) Int. Cl. B60S 1/38; B60S 1/40

(52) U.S. Cl. 15/250.43; 15/250.32

(57) ABSTRACT

A wiper blade is proposed, which is used for cleaning windows of motor vehicles. The wiper blade has a band-like, elongated, spring-elastic carrying element (30) whose one band surface oriented away from the window (24) has a device (32) for the connection of an oscillatingly driven wiper arm (34) disposed on it and whose other band surface oriented toward the window has an elongated, rubber-elastic wiper strip (17) disposed on it that can be placed against the window (24) and is disposed so that its longitudinal axis is parallel to the carrying element, and the wiper arm moves the wiper blade lateral to its longitudinal span during the wiping operation, wherein the carrying element moves in a plane essentially parallel to the window surface. A reliable and low-noise tilting over of the wiper lip belonging to the wiper strip from its one drag position into the other is achieved when in each of the two oscillating directions (12, 26) viewed perpendicular to the window surface, a straight line (38) extending through the longitudinal center of the two ends of the wiper blade is disposed behind the center (40) of the connecting point between the wiper arm (34) and the wiper blade (10) in the respective wiping direction.

### PRIOR ART

In wiper blades of the type described in the preamble to claim 1, the carrying element is intended to assure a uniform distribution of the wiper blade pressure against the window, which pressure comes from the wiper arm, over the entire wiping field swept across by the wiper blade. Through a corresponding curvature of the unstressed wiper blade—i.e. when the wiper blade is not resting against the window—the ends of the wiper strip, which are placed completely against the window during the operation of the wiper blade, are loaded toward the window by the carrying element which is then stressed, even when the curvature radii of spherically curved vehicle windows change with each wiper blade position. The curvature of the wiper blade in relation to the window surface must therefore be slightly sharper than the sharpest curvature measured in the wiping field on the window to be wiped. The carrying element consequently replaces the expensive support bracket construction with two spring rails disposed in the wiper strip, as is practiced in conventional wiper blades (Published, non-examined German patent 1505357).

The invention is based on a wiper blade according to the preamble to claim 1. In a known wiper blade of this type, which is called a window wiper or wiper blade (EP 0594451), the carrying element is constituted by a spring rail whose surface oriented toward the window has a wiper blade glued to it, which essentially corresponds to the wiper strip according to the invention. The carrying element of this wiper blade is distinguished by a high degree of lateral rigidity, which is intended to prevent rattling noise due to an erratic action. However, with wiper blades of this kind, noise problems arise in the reversal positions.

For the comprehension of this problem, particular reference is made to FIGS. 2 to 4, which are intended to clarify the behavior of the wiper blade during its back and forth wiping or working motion. When the wiper blade 10 has finished its movement in one direction shown in FIG. 4 with the arrow 12—i.e. when it has reached its reversal position—its wiper lip 18, which is connected to a wiper strip body 16 by way of a tilting piece 14, is disposed in a drag position in relation to the wiper strip body 16, which drag position is essential for a good wiping result and for a low-noise wiping operation. The wiper lip 18 is supported at 20 with a longitudinal edge against the wiper strip body 16 so that the contact pressure (arrow 22) acts on the wiper lip 18 and on the window 24 to be wiped. If the return or reverse motion is then begun (arrow 26 in FIG. 3) then the wiper lip 18 must, for the recent mentioned above, be transferred from its one drag position (FIG. 4) into its other drag position (FIG. 3). In this connection, the wiper lip 18 remains temporarily stationary in its achieved position in relation to window 24 so that the wiper blade first reaches the position which is shown in FIG. 2 before the wiper lip 18 tilts into its other drag position shown in FIG. 3. Only then does the actual wiping motion of the wiper blade 10 and the wiper lip 18 begin in relation to the window 24. The transfer of the wiper lip 18 from its one drag position (FIG. 4) into the other drag position (FIG. 3) is consequently connected with an up and down motion (double arrows 28 in FIGS. 3 and 4) of the wiper blade 10 whose highest position is shown in FIG. 2 and is reached in a middle position between the two drag positions. This up and down motion occurs abruptly and simultaneously over the entire length of the wiper strip 14, 16, 18. This snapping over is connected with a considerable, unpleasant knocking noise.

### ADVANTAGES OF THE INVENTION

In the wiper blade according to the invention, with the characterizing features of claim 1, before the transfer of the wiper lip from its one drag position into its other drag position and before the beginning of the actual wiping work over the entire length of the wiper lip, a so-called no-load motion is required, by means of which the center of the connecting point is brought into the respective wiping direction before the straight part. During this no-load motion—in which the ends of the wiper blade preferably remain stationary—the change of the wiper lip drag position according to FIGS. 2 to 4 starts from the center region of the wiper blade, and progresses continuously until the drag position now required has been achieved over the entire length of the wiper lip and the actual working motion of the wiper blade begins. Because the tilting over process of the wiper lip is initiated starting from its center region and continuously progresses from there in a time-delayed fashion until its two ends, the instantaneous snapping over of the wiper lip from the one drag position into the other drag position is prevented so that the unpleasant knocking noise is therefore also eliminated. In this connection, it is helpful but not absolutely necessary that one or both ends are not moved into the new wiping direction until the entire wiper lip has been transferred into the new drag position. It is essential that with regard to the wiping direction, at least one end lags until the transfer of the wiper lip into the new drag position has begun in at least one point.

This effect is achieved in a particularly reliable manner if the distance from the straight parts to the center of the connecting point is greater than 1 mm.

Manufacturing advantages ensue from the fact that the thickness of the carrying element is the same over its entire longitudinal span.

According to a first embodiment of a wiper blade according to the invention, the width of the carrying element measured in the wiping direction is smaller at its end regions than in its center region. As a result, it is possible to influence the cross section of the carrying element so that solely the friction between the wiper lip and the window existing during the wiping process on the one hand and the drive force of the wiper arm acting on the carrying element on the other hand, achieves a deflection of the two carrying element end sections counter to the respective wiping direction in the carrying element movement plane, which results in the fact that the straight line extending through the longitudinal center of the two carrying elements travels behind the center of the connecting point between the wiper arm and the wiper blade. In this connection, it has turned out that the carrying element ends embodied in accordance with this feature do not have a disadvantageous effect on the wiping quality.

In order to prevent inconvenient corners on the carrying element, the tapering of the carrying element width occurs continuously.

According to a modification of the first embodiment of the wiper blade according to the invention, the carrying element is divided in the longitudinal direction, wherein the two carrying element rails thus formed are disposed in lateral longitudinal grooves of the wiper strip and the device for connecting the wiper blade arm is disposed on sections of the carrying element rails that protrude from the longitudinal grooves. As a result, it is possible to utilize the advantages of the invention even in those instances in which a longitudinally divided carrying element should be used for particular reasons.

In another embodiment of the wiper blade according to the invention, the carrying element is divided laterally in its center section and the two carrying element parts thus formed can each oscillate in relation to the connecting device for the wiper arm around a respective axis that is aligned perpendicular to the window surface. This measure gives the wiper blade a V-shape when viewed from above that changes depending on the wiping direction so that the straight line extending through the two end sections of the carrying element ends travels behind the center of the connecting point between the wiper arm and the wiper blade, counter to the respective wiping direction.

A low-profile wiper blade of this type is achieved if each of the carrying element parts has an oscillation axis associated with it.

In particular practical applications, it can also be useful if the two carrying element parts overlap with an extension and in the overlapping region, have a common oscillation axis associated with both of the carrying element parts.

For technical manufacturing reasons it is advantageous if the thickness of the carrying element parts is the same over its entire longitudinal span.

In order to balance a particular, desirable contact force distribution over the wiper blade length, the width of the carrying element parts measured in the wiping direction is smaller at their end regions than in their center regions, wherein the advantages mentioned above ensue when the tapering in the width of the two carrying element parts occurs continuously.

In order to prevent an impermissible reduction of the wiping field, the oscillating motion of the carrying element parts is limited in their reversal positions by means of stops.

Other advantageous improvements and updates of the invention are disclosed in the following description of exemplary embodiments shown in the accompanying drawings.

### DRAWINGS

FIG. 1 is a perspective representation of a first embodiment of a wiper blade according to the invention,

FIGS. 2 to 4 are enlarged depictions of sectional planes through the wiper blade according to FIG. 1 along the line II-II, wherein the wiper blade is respectively disposed in different operating positions,

FIG. 5 is a top view of a carrying element belonging to the wiper blade according to FIG. 1, which shows its form when the wiper blade is disposed in the neutral position,

FIG. 6 shows the form of the carrying element according to FIG. 5 when the wiper blade is wiping toward the right,

FIG. 7 shows the form of the carrying element according to FIG. 5 when the wiper blade is wiping toward the left,

FIG. 8 is a top view of another embodiment of the carrying element when the wiper blade is disposed in the neutral position,

FIG. 9 shows the form of the carrying element according to FIG. 8 when the wiper blade is wiping toward the right,

FIG. 10 shows the form of the carrying element according to FIG. 8 when the wiper blade is wiping toward the left,

FIG. 11 is a perspective view of another embodiment of the carrying element according to FIG. 8,

FIG. 12 is an enlarged depiction of the sectional plane of a section through the wiper blade along the line XII-XII in FIG. 1,

FIG. 13 shows a cross section corresponding to FIG. 12 through a wiper blade according to the invention in which the carrying element is in contrast longitudinally divided, and

FIG. 14 is a top view of the carrying element according to FIG. 13, in which the connecting devices for the wiper arm and the wiper strip are depicted with dot-and-dash lines.

### DESCRIPTION OF THE EXEMPLARY EMBODIMENTS

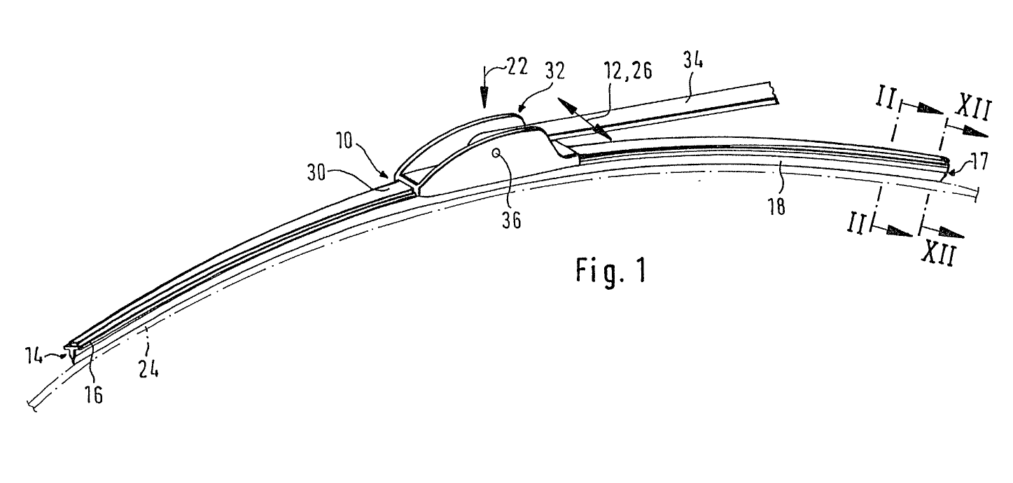

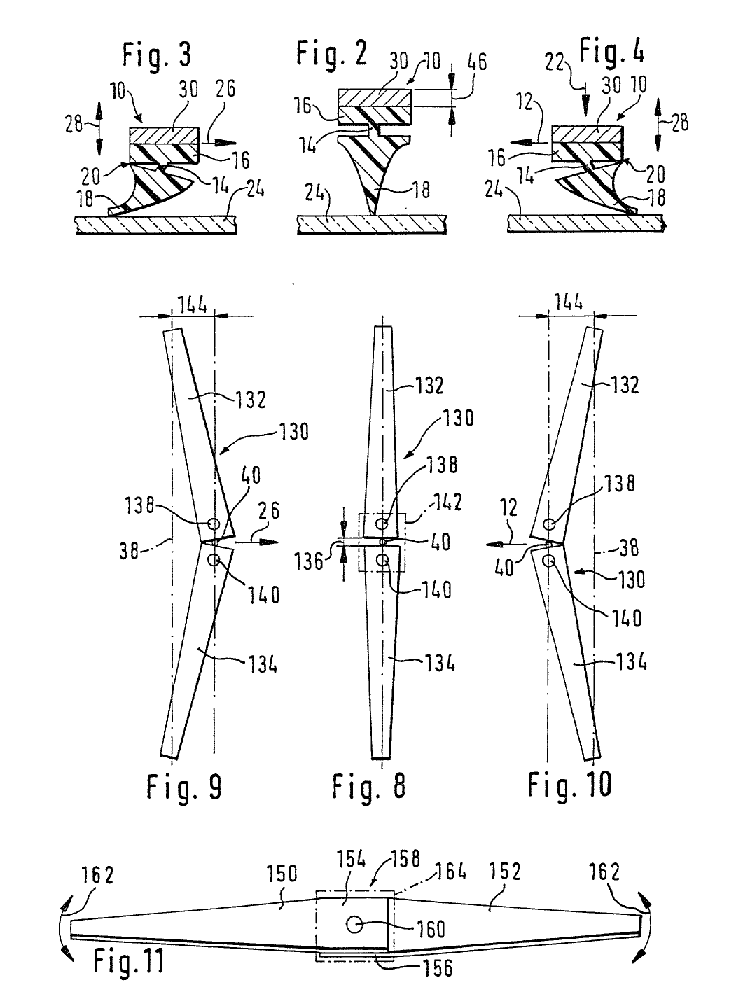

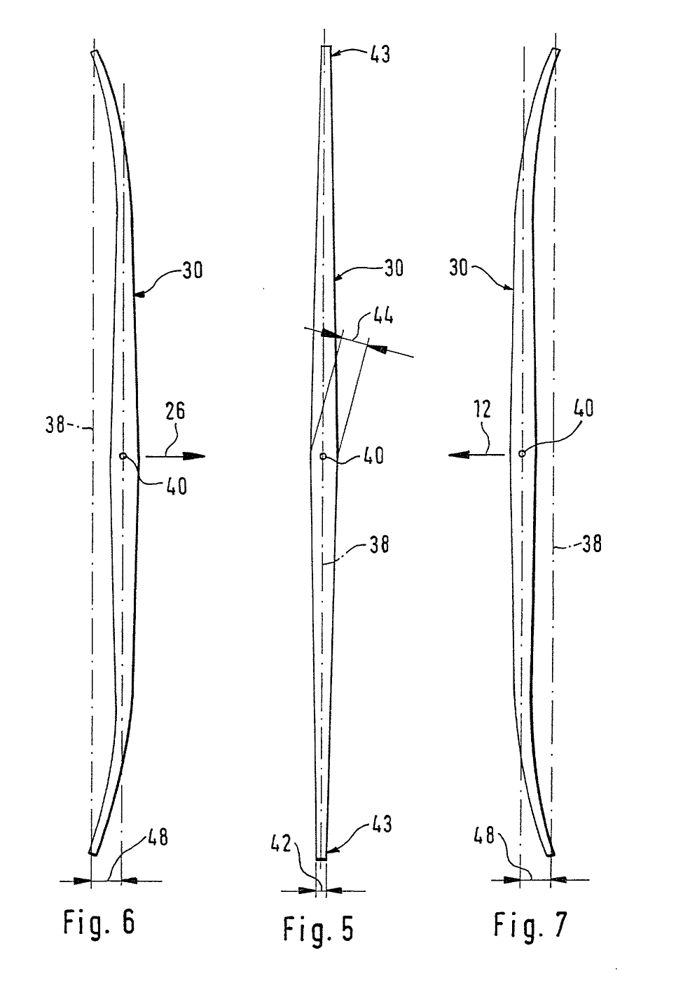

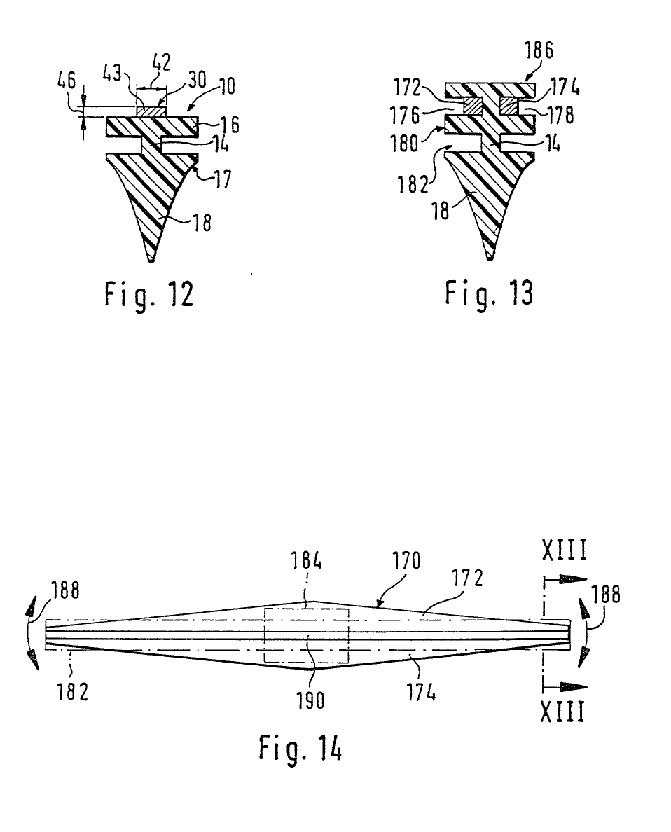

A wiper blade 10, which is shown in a perspective view in FIG. 1 and is for cleaning motor vehicle windows, is provided with a band-like, elongated, spring-elastic carrying element 30, which in the exemplary embodiment is made of a spring band steel. This carrying element 30, however, can also be made of a different material, for example a plastic, which has the necessary properties to fulfill the purpose of the carrying element 30. A wiper strip 17 is fastened with its wiper strip body 16 to the band surface of the carrying element 30 oriented toward the window 24 to be wiped, and a wiper lip 18 that can be placed against the window 24 is secured by way of a narrow tilting piece 14 to the side of this wiper strip body 16 oriented toward the window 24. Over its entire length—which corresponds approximately to the length of the carrying element 30—the elongated wiper strip 17 has a cross section that is essentially the same. The wiper strip 17 is placed on the carrying element 30 in such a way that the respective longitudinal axes of these components extend parallel to each other. A device 32 for connecting a wiper arm 34 that is driven to oscillate is attached to the band surface of the carrying element 30 remote from the window 24. The free end of a wiper arm 34 engages with a pivot bolt 36 of the connecting device 32 in an intrinsically known fashion. The wiper arm 34 is pressed against the window 24 to be wiped by means of a contact force (arrow 22). In the exemplary embodiment, the wiper blade is driven in a reciprocating fashion lateral to its longitudinal span with the aid of the wiper arm. In this reciprocating motion, which is indicated in FIG. 1 by the double arrow 12, 26, the carrying element 30 is moved in a plane essentially parallel to the window surface. The construction of the elongated wiper blade described above—with the exception of the connecting device 32—can be inferred in a particularly clear manner from the above-described FIG. 2. The top view of the carrying element 30 of the wiper blade 10 depicted in FIG. 5 shows that a straight line 38 extending through the longitudinal center of the two ends of the wiper blade also intersects the center 40 of the connecting point between the wiper arm and the wiper blade. With regard to FIG. 1, this center 40 is disposed on the pivot bolt 36 in its center region. The configuration of the carrying element 30 show in FIG. 5 is produced when the wiper blade is lifted up from the window and is placed back onto the window 24 without a drive motion. Furthermore, FIG. 5 shows that the width of the carrying element 30 measured in the wiping direction (double arrow 12, 26) is smaller at its end sections or end regions 43 than in its center region 44. This described tapering of the carrying element toward its ends occurs continuously. It can be dimensioned so that the width 42 of the carrying element end regions 43 is narrower than the width of the wiper strip body 16 (FIG. 12). The thickness 46 of the carrying element 30 is the same over its entire longitudinal span, at least in a carrying element 30 that is made of spring band steel. The tapering described above is balanced so that the two end sections 43 of the carrying element 30 can be elastically deflected in the wiping direction (double arrow 12, 26). The deflection, which is provided with the reference numeral 48 in FIGS. 6 and 7 and is greater than one millimeter, is achieved by the strip 17, which is placed against the window with the pressure (arrow 22). The working motion of the wiper blade is transmitted directly to the wiper strip 17, namely in the rigid center region of the carrying element, while in the comparatively flexible end sections 43 of the carrying element 30, first a so-called drag tension must be built up, which must be greater than the friction between the wiper lip 18 and the window 24. Consequently, depending on the wiping direction, arrow 12 FIG. 7 or arrow 26 FIG. 6, the straight line 38 extending through the longitudinal center of the two ends 43 of the wiper blade is disposed offset by the measure 48 in the respective wiping directions, behind the center 40 of the connecting point between the wiper arm 34 and the wiper blade 10.

Another embodiment of the wiper blade according to the invention is schematically depicted by FIGS. 8 to 10. They show operating positions of the wiper blade carrying element that are comparable to those in FIGS. 5 to 7. In this embodiment, however, the carrying element 130 is divided laterally and consequently has two carrying element parts 132, 134. The ends of the carrying element parts 132, 134 oriented toward each other are disposed at a slight distance 136 from each other. They are both connected at the end sections oriented toward each other by way of a respective joint 138, 140 associated with each of them to the connecting device 142 that is for the wiper arm and is depicted with dot-and-dash lines in FIG. 8. The axes of the joints 138 and 140 are aligned perpendicular to the window surface. When the wiper blade is in the neutral position, the center 40 of the connecting point between the wiper arm and wiper blade is disposed in the region of the spacing distance 136. The size of the spacing distance 136 is dimensioned so that the two free outer ends of the two carrying element parts 132, 134 can execute a deflecting motion in accordance with the deflection 48 (FIGS. 6 and 7), which makes it possible that when the wiper blade is in the wiping operation, depending on the wiping direction (arrow 12 or arrow 26), a straight line 38 extending through the two ends of the wiper blade is disposed behind the center 40 of the connecting point between the wiper arm and wiper blade in the respective wiping direction 12 or 26. This spacing dimension is indicated in FIGS. 9 and 10 by the reference numeral 144. During the wiping operation, this deflection 144 is achieved by means of the conditions mentioned above in conjunction with FIGS. 5 to 7. A corresponding matching of the spacing 136 produces a limitation of the deflection because the ends of the carrying element parts 132, 134 oriented toward each other are supported against one another.

FIG. 11 shows another embodiment of the wiper blade according to the invention, which is similar to the embodiment described above. In contrast to the embodiment according to FIGS. 8 to 10, the two carrying element parts 150, 152 in this instance are each provided with an extension 154, 156 and these extensions overlap each other at the ends oriented toward one another. A common joint 160 associated with both of the carrying element parts 151, 152 is disposed in this overlapping region 158 and permits a limited pivoting motion (double arrow 162) for the two carrying element parts 151, 152. The behavior of the carrying element according to FIG. 11 essentially corresponds to the behavior of the carrying element according to FIGS. 8 to 10 during the wiping operation because here, too, both of the carrying element parts 150, 152 can be pivoted (double arrows 162) in relation to the connecting device 164 schematically depicted with dot-and-dash lines by means of the common joint 160.

In particular practical applications, it can be advantageous if the carrying element—as shown in FIGS. 13 and 14—is divided in the longitudinal direction. As a result, two carrying element rails 172 and 174 are produced, which constitute a single carrying element and are disposed in longitudinal grooves 176, 178 that are situated on the side, are open at the edges toward the longitudinal side, and are disposed essentially parallel to each other in the wiper strip body 180 (FIG. 13).

FIG. 14 shows a top view, not to scale, of a longitudinally divided carrying element 170 of this kind, wherein in FIG. 14, both the position of the wiper strip 182 and the position of the connecting device 184 are indicated with dot-and-dash lines. Except for this longitudinal division and the placement of the two carrying element rails 172, 174 in the longitudinal grooves of the wiper strip, the wiper blade 186 according to FIGS. 13 and 14 corresponds to the wiper blade according to FIG. 1, with the one-piece carrying element according to FIGS. 5 to 7 and 12. It is clear that the carrying element rails 172, 174 are in fact spaced apart from each other, but as a whole, correspond completely to the carrying element 30 according to FIGS. 1, 5 to 7, and 12. During the wiping operation, depending on the wiping direction, the carrying element ends consequently can also be deflected in one of the two directions indicated by the double arrows 188 so that a straight line extending through the common longitudinal center of the two ends of the wiper blade is disposed behind the center 190 of the connecting point between the wiper arm and the wiper blade in the respective wiping direction. In this embodiment of the wiper blade, the device for connecting the wiper blade to the wiper arm is disposed on the center sections of the carrying element rails 172, 174 protruding from the longitudinal grooves 176, 178.

By means of the current measures, which have been described as exemplary embodiments in conjunction with FIGS. 5 to 7, 9 to 11, and 12, 13, it is possible that in each of the two oscillation directions 12, 26, viewed perpendicular to the window surface, a straight line 38 extending through the longitudinal center of the two ends 43 of the wiper blade 10 is disposed behind the center 40 of the connecting point between the wiper arm and the wiper blade in the respective wiping direction. In other words, during the wiping operation, the wiper blade can essentially be deformed in the plane disposed parallel to the window surface in such a way that its two ends 43 lag in relation to the center 40 of the pivot connection between the wiper blade connecting device 32 and the wiper arm 34 in the respective wiping direction 12, 26. As a result, starting from the wiper blade center, a gradual, continuous tilting over of the wiper lip 18 from the one drag position into the other is achieved so that unpleasant noises are prevented.

Viewed in terms of the wiping direction, the lagging of one or both of the ends of the carrying element in relation to its connecting point for the wiper arm is produced in wiper blades, as in the exemplary embodiments described here, by means of a retention force which acts in opposition to the wiping motion due to the pressing force of the wiper strip against the window and the resulting friction against the carrying element produced during the wiping motion. The deflection, however, can also be produced actively by means of elements attached to or in the carrying element, e.g. by means of catch springs.

1. A wiper blade for cleaning windows of motor vehicles, having a band-like, elongated, spring-elastic carrying element (30) whose one band surface oriented away from the window (24) has a device (32) for the connection of an oscillatingly driven wiper arm (34) disposed on it and whose band surface oriented toward the window has an elongated, rubber-elastic wiper strip (17) disposed on it that can be placed against the window and is disposed so that its longitudinal axis is parallel to the carrying element, and the wiper arm moves the wiper blade lateral to its longitudinal span during the wiping operation, wherein the carrying element moves in a plane essentially parallel to the window surface, characterized in that in each of the two oscillating directions (12, 26) viewed perpendicular to the window surface, a straight line (38) extending through the longitudinal center of the two ends of the wiper blade is disposed behind the center (40) of the connecting point between the wiper arm (34) and the wiper blade (10) in the respective wiping direction.

2. The wiper blade according to claim 1, characterized in that the distance (48 or 144) of the straight line (38) from the center (40) of the connecting point is greater than 1 mm.

3. The wiper blade according to one of claims 1 or 2, characterized in that the thickness of the carrying element (30, 130, 170) is the same over its entire longitudinal span.

4. The wiper blade according to one of claims 1 to 3, characterized in that the width of the carrying element (30, 130, 170) measured in the wiping direction is smaller at its end regions (43) than in its center region (44).

5. The wiper blade according to claim 4, characterized in that the tapering of the carrying element width occurs continuously.

6. The wiper blade according to one of claims 1 to 5, characterized in that the carrying element (170) is divided in the longitudinal direction, that the carrying element rails (172, 174) thus produced are disposed in lateral longitudinal grooves (176, 178) of the wiper strip (182) and the device for connecting the wiper arm is disposed on sections of the carrying element rails (172, 174) that protrude from the longitudinal grooves.

7. The wiper blade according to one of claims 1 to 5, characterized in that the carrying element (130) is divided laterally in its center section and the two carrying element parts (132, 134) can each oscillate in relation to the connecting device (142) for the wiper arm around a respective axis aligned perpendicular to the window surface.

8. The wiper blade according to claim 7, characterized in that each of the carrying element parts (132, 134) has an oscillation axis associated with it.

9. The wiper blade according to claim 7, characterized in that the two carrying element parts (150, 152) overlap with an extension (154, 156) and in the overlap region (158), have a common oscillation axis associated with both carrying element parts.

10. The wiper blade according to one of claims 7 to 9, characterized in that the oscillating motion of the carrying element parts (132, 134 or 150, 152) in their reversal positions is limited by means of stops.

11. A wiper blade for cleaning windows of motor vehicles, having a band-like, elongated, spring-elastic carrying element (30) whose one band surface oriented away from the window (24) has a device (32) for the connection of an oscillatingly driven wiper arm (34) disposed on it and whose band surface oriented toward the window has an elongated, rubber-elastic wiper strip (17) disposed on it that can be placed against the window and is disposed so that its longitudinal axis is parallel to the carrying element, and the wiper arm moves the wiper blade lateral to its longitudinal span during the wiping operation, wherein the carrying element moves in a plane essentially parallel to the window surface, characterized in that when the oscillating direction reverses, at least one end of the wiper blade lags with regard to the wiping direction until the transfer of the wiper strip (17) into the new drag position has begun in at least one point.
